(19) United States
(12) Patent Application Publication
(10) Pub. No.: US 2008/0202790 A1
(43) Pub. Date: Aug. 28, 2008

(54) Cover Plate And Group Of Parts For Wall Mounting An Electrical Apparatus

(75) Inventors: Fabrizio Fabrizi, Bergamo (IT); Renato De Ambroggi, Varese (IT)

Correspondence Address: HOGAN & HARTSON LLP, ONE TABOR CENTER, SUITE 1500, 1200 SEVENTEENTH ST, DENVER, CO, 80202, US

(73) Assignee: BTICINO SpA, Milano (IT)

(21) Appl. No.: 11/910,877

(22) PCT Filed: Apr. 3, 2006
(86) PCT No.: PCT/IT06/00219

§ 371 Date: Dec. 12, 2007

(30) Foreign Application Priority Data
Apr. 7, 2005 (IT) RM2005A000161

(51) Int. Cl. H02G 3/12

(52) U.S. Cl. 174/66

(57) ABSTRACT

Cover plate (1, 21) for the wall application of at least one electrical apparatus (20), characterised in that it comprises: —a base (2) having a through opening (3) adapted to receive a front portion of said at least one electrical apparatus (20); —a mask (4), which can be coupled to the base (2), equipped with a window (5) cooperating with said through opening (3) and it too adapted to receive a front portion of said electrical apparatus (20); —at least one fixing element (6) including, a first portion (9) adapted to project inside said window towards said base (2) and comprising coupling means (10, 14) of said element to said base (2), said fixing element including (6) moreover a second portion (7) adapted to cooperate with at least one surface portion (8) of said mask (4) facing said window (5) to fix said base (2) to said mask (4).

The present invention refers to the technical sector of the devices for the wall mounting of electrical apparatuses, and more particularly regards a cover plate and a composite structure, or group of parts, including such plate, for the wall mounting of an electrical apparatus.

Regarding the present description, for electrical apparatus it is intended, in general, any one means or electrical device generally making up part of electrical installations in civil buildings and the like and normally intended to be mounted, for example embedded, in walls of such buildings.

This definition therefore includes, not exclusively, switches, electrical sockets, sockets for data networks, TV sockets, telephone sockets, commutators, deviators, general electrical adjustment devices, connectors, thermostats, timers, fuse carriers, bells/buzzers, emergency lamps for example of removable type, signal lamps for example footlights, displays such as LCD and the like.

As is known, most of the above mentioned electrical apparatuses are usually installed on walls by using composite mounting structures, or groups of parts, generally including:
a box intended to be embedded in the wall;
an apparatus carrier (or flush) mounting frame which can be fixed to the box; and a cover plate which can be fixed to the frame and provided with an opening to allow a user's visual or manual access to the electrical apparatuses intended to be installed on the flush mounting frame.

Such mounting structures often have modular structure to permit, using a same mounting group, the wall installation of electrical apparatuses of different type and in numerous configurations, arrangements and combinations, which may even be personalised and modified over time. In such a manner, the producers are able to renew complete product lines by considerably limiting the number of components to be projected, tested and inserted in production.

In the above indicated mounting structure, the role of the cover plate is that of ensuring a minimum protection for the electrical devices, for example from dust, as well as that blocking dangerous access (for example through pointed objects) to the electrically conductive parts of the electrical apparatuses. Another fundamental task assigned to the cover plates is also that of hiding slight blemishes produced, for example by the presence of a cavity in the wall, and from the presence of the box and mounting frame, which in addition to having an aesthetic value, has a functional value not likely to be compatible with aesthetic requirements or canons.

Still more often, it also occurs that the cover plates are not only used for hiding blemishes, but are even aesthetic furnishing elements in themselves, i.e. elements which carry out an important role in the formation and characterisation of the furnishing of an internal setting.

In particular, to such end, it is known to produce the cover plates in different colours, materials and shapes to permit the adaptation of these to the settings in which these are installed, thus satisfying the requirements and the needs of different consumers.

Nevertheless, it is clear that from the production standpoint, making available numerous plates of different colours, materials and shapes considerably complicates the storage production processes by a producer. This puts a series limit to the range of models available on the market for the plates, in order to avoid an excessive increase in the investments and production costs.

Moreover, in the current state of the art, there are intrinsic practical and also economical limits in manufacturing, regarding the production of cover plates for electrical apparatuses, of particular materials such as wood, glass, crystal, rock and metals (even precious).

It is therefore understandable how in the sector of plate production there are contrasting productive technical needs and commercial needs: on the one hand, indeed, for the production simplification, the lowering of the related costs and a simpler management of the supply it would be better to not have an excessive diversification among different cover plate models, while on the other hand to better satisfy the requirements of the market it would be opportune to have a maximum variety of available shapes, colourings, and materials—as well as fantasy.

The present invention proposes to offer a solution which permits reconciling such opposing needs; in other words, the present invention thus proposes to make a cover plate for electrical apparatuses applied to walls with characteristics such to permit a production of the same with a wider availability of models, shapes, and materials, at the same time overcoming the limits mentioned in relation to the prior art.

Such object is attained by means of a cover plate as defined in the attached first claim, in its most general form, and in the dependent claims in several particular embodiments.

A further aspect of the present invention is that of making available a group of parts for the wall mounting of electrical apparatuses as defined in the attached claim 16.

The invention will be better understood from the following detailed description of one of its preferred embodiments, made as exemplifying and therefore in no manner limiting in relation to the drawings, wherein:

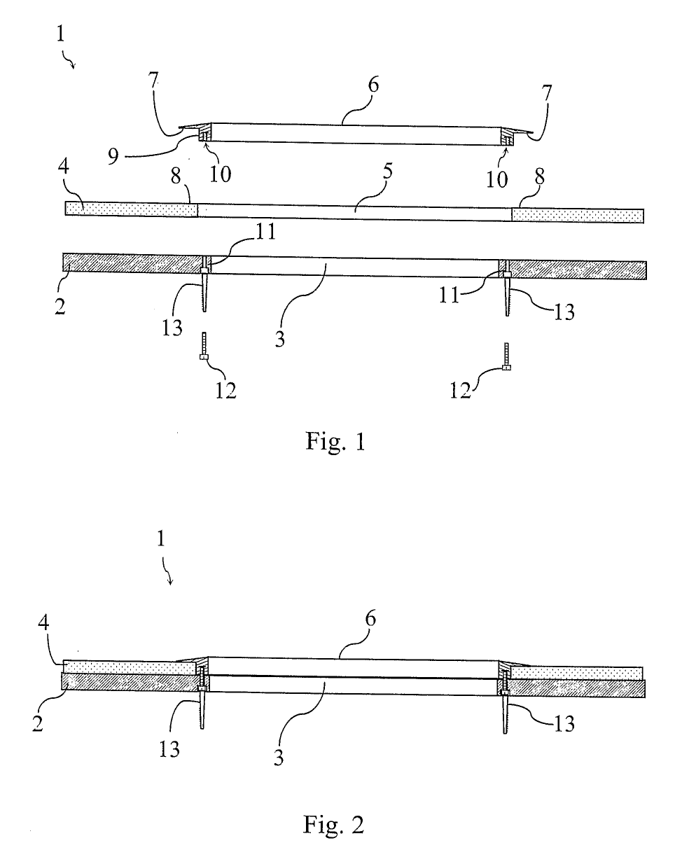

FIG. 1 shows a lateral section view with separated parts of a first embodiment of a cover plate in accordance with the present invention,

FIG. 2 is a lateral section view, with parts assembled, of the plate of FIG. 1;

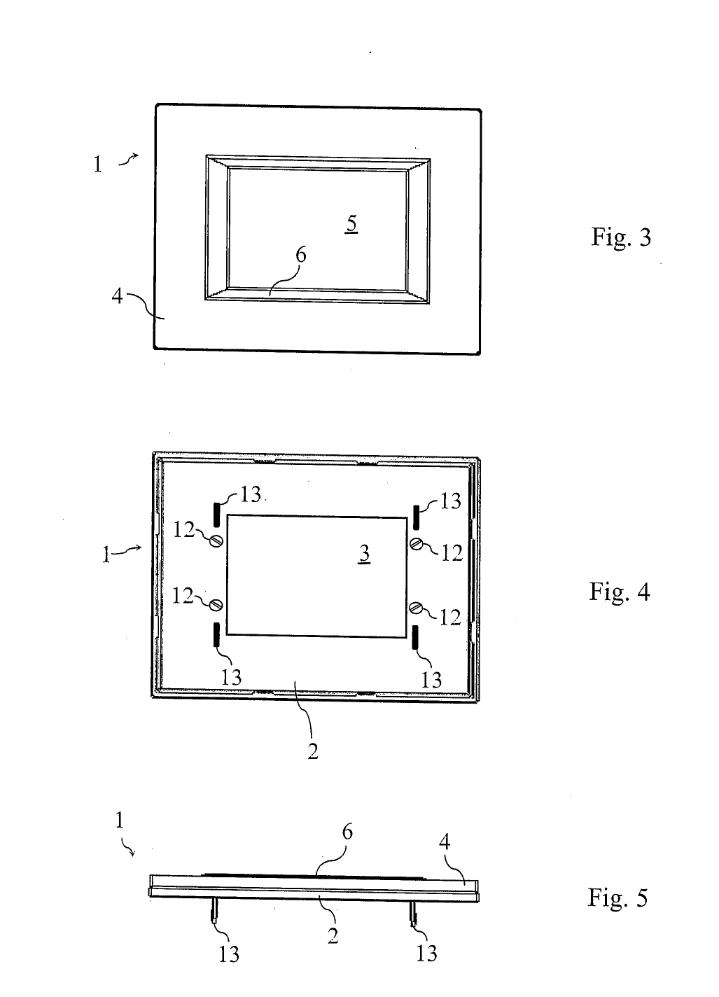

FIG. 3 shows a plane plan view of the plate of FIG. 1;

FIG. 4 shows a plane rear view of the plate of FIG. 3;

FIG. 5 shows a lateral view of the plate of FIG. 1;

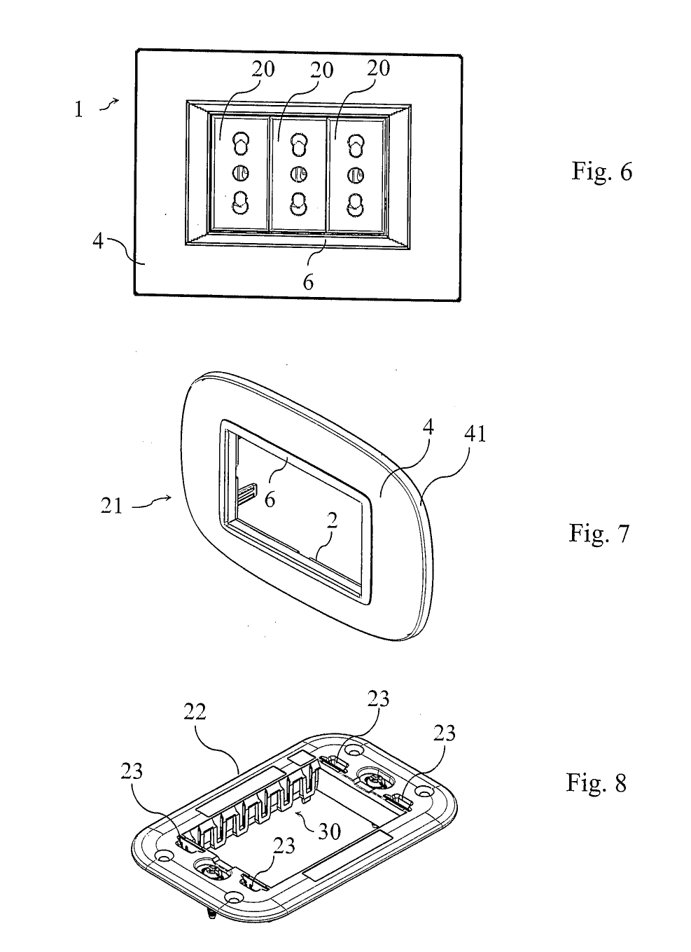

FIG. 6 is a plane plan view of the plate of FIG. 1, wherein three electrical apparatuses are also shown whose front portion is received in the opening defined in the plate;

FIG. 7 is a perspective view of a second cover plate embodiment in accordance with the present invention;

FIG. 8 is a perspective view of a flush mounting frame which can be coupled to a cover plate in accordance with the present invention;

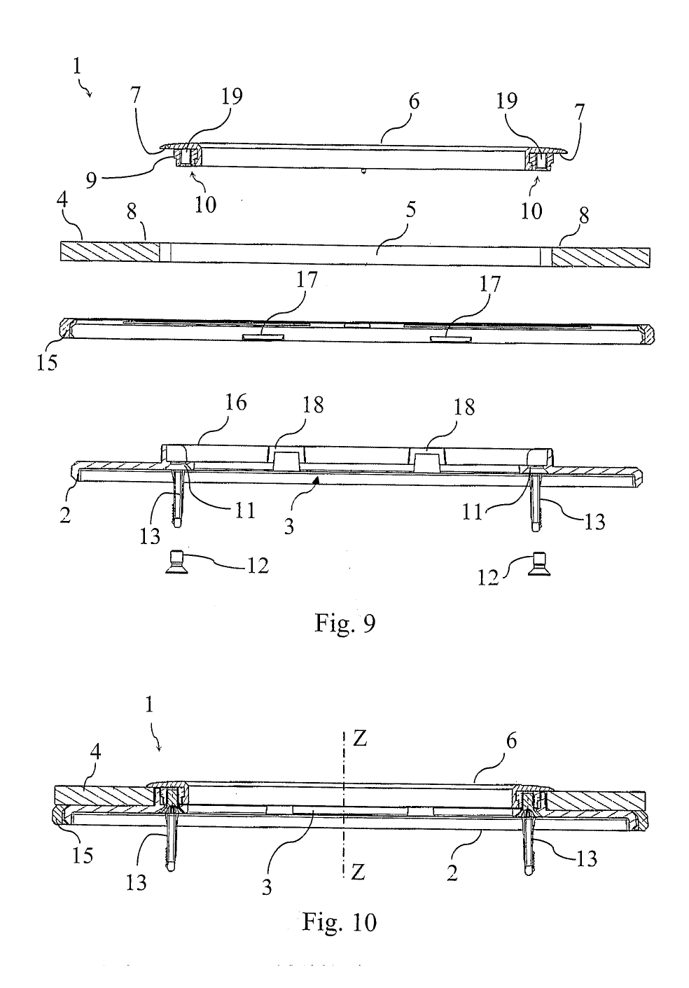

FIG. 9 shows a lateral section view with separated parts of a third embodiment of a cover plate in accordance with the present invention;

FIG. 10 is a lateral section view, with parts assembled, of the plate of FIG. 9;

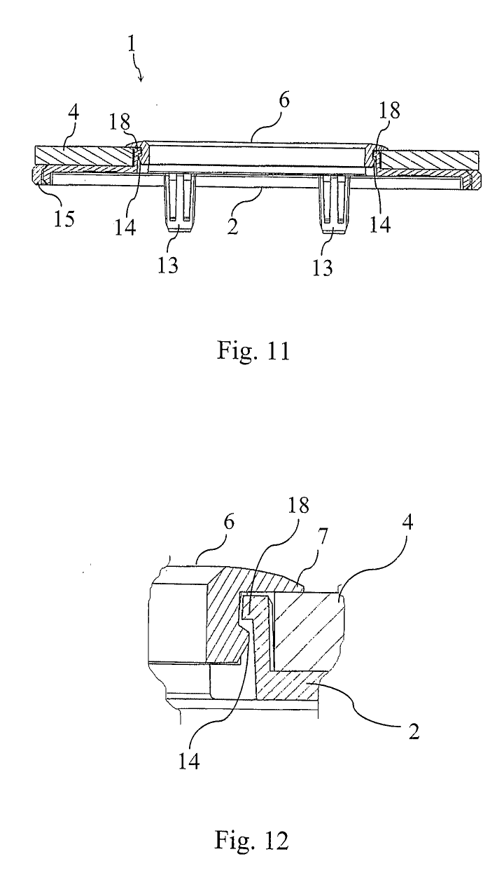

FIG. 11 is a lateral section view along the Z-Z axis of the cover plate of FIG. 9;

FIG. 12 shows an enlarged detail of the plate of FIG. 11.

In the figures, equivalent or similar elements are indicated with the same numeric references.

In FIGS. 1-6, a first particularly preferred embodiment of a cover plate is shown, indicated in its entirety with 1, in accordance with the present invention. The cover plate 1 may be employed for the wall application of at least one electrical apparatus. A particular set comprising a cover plate 1 and at least one electrical apparatus is represented in FIG. 6, wherein three electrical apparatuses 20 are visible in the form of network current sockets. Nevertheless, the example of FIG. 6 is not limiting, thus a different number of electrical apparatuses and different types of electrical apparatuses may be associated with the plate 1.

The plate 1 can be fixed, preferably in a removable manner, to a flush mounting frame which in turn may be fixed to a wall, for example by means of a box embedded in the same wall. In such a manner, the plate and the frame therefore define a group of parts, possibly also including an embedded box, for the wall application of one or more electrical apparatuses.

A particular flush frame example is represented in FIG. 8 and is entirely indicated with 22. In such figure, coupling means 30 are also visible, comprised in the frame and provided for holding electrical apparatuses 20.

With reference to FIG. 1, the cover plate 1 includes a base 2, having a through opening 3 adapted to receive a front portion of the electrical apparatus 20 to apply to the wall. In practice, the opening 3 is defined in the thickness of the base 2 and is such to be able to permit a user to establish a tactile or visual interaction with the electrical apparatus to apply to walls.

In the particular example of FIGS. 1-6, the base 2 not restrictively is a plate 2 having a substantially quadrangular plan, for example rectangular. Nevertheless, other shapes are possible for the base 2 which for example could also have a variable thickness or could have a different plan. The base 2, for example, may be quadrangular with round corners, square, circular or elliptical, etc. Preferably, but not restrictively, the base 2 is made by moulding a polymeric material, for example in hard plastic.

The through opening 3 is preferably defined in a substantially central portion of the base 2 and is also quadrangular, for example rectangular. As for the base 2, varied forms and arrangements are nevertheless possible for the through opening 3.

The cover plate 1 moreover includes a mask 4, which can be coupled to the base 2 and is provided with a window 5 cooperating with the through opening 3, it too adapted to receive a front portion of the electrical apparatus 20 to apply to walls. In the particular example of FIGS. 1-6, the mask 4 has a plan characterised by a conformation similar to the conformation of the base 3, such that the opening 3 and the window 5 are substantially coaxial. It should be nevertheless understood that the shape and size of such mask 4 are not bound to be adapted to the size of the base 2 and that, for example, the mask 4 may have a very different profile or plan with respect to the profile and plan of the base 2.

Regarding the materials, the mask 4 may be made in a multitude of different materials: in stone, for example slate or marble, in metal, such as steel, aluminium or zama (zinc, aluminium, copper alloy), in wood, also precious, in transparent or opaque glass etc.

Preferably, as shown in FIGS. 1-6, the opening 3 of the base 2 has slightly smaller dimensions with respect to the window 5 of the mask 4, so that when the mask 4 superimposes the base 2, a stepped profile is defined between an edge portion of the base 2 facing the opening 3 and a corresponding edge portion of the mask 4 facing the window 5.

At least one fixing element 6 is provided for fastening together the base 2 and the mask 4, acting by interference with a surface portion 8 of the mask 4 facing the window 5.

More in detail, the fixing element 6 includes a first portion 9 which projects inside the window 5 towards the base 2. Such portion 9 includes means 10 to mechanically couple the fixing element 6 to the base 2.

The fixing element 6 includes, moreover, a second portion 7, for example projecting coplanar with respect to the mask 4, adapted to cooperate by interference with a surface portion 8 of the mask 4 projecting from the window 5. In the example of FIGS. 1 and 2, the first portion 9 and the second portion 7 of the fixing element 6 are connected with each other so to define an undercut adapted to hold the mask 4 bound to the base 2 when the fixing element 6 is coupled to the base 2.

Preferably, as shown in FIGS. 1 and 2, the fixing element 6 is such to cooperate by interference with the surface portion 8 of the mask 4 to pressure tighten the mask 4 against the base 2.

In a particularly preferred embodiment, the fixing element 6 is such to interfere with a surface portion 8 of the mask 4 corresponding with a continuous edge portion 8 of the mask 4 which surrounds the window 5. Alternatively, in embodiments not shown in the figures, several distinct fixing elements 6 are foreseen on respective edge portions 8 of the mask which are discontinuous with each other.

It is observed that in the particular examples represented in the figures, the fixing element 6 has an annular form and, in practice, is made in a frame 6 which can be coupled to the base 2 and is substantially coaxial with the window 5 of the mask 4 and opening 3 of the base 2.

Preferably, the frame 6 can be coupled in a removable manner to the base 2. For example, as represented in FIG. 1, the frame 6 includes one or more internally threaded seats 10 which face towards the base 2, and the latter includes corresponding through holes 11 for coupling the frame and the base 2 by means of screws 12 crossing such through holes 11 and which can be screwed in respective seats 10 of the frame 6. In the case in which the frame 6 is made in plastic material, or more generally in easily deformable material, it is preferably that the threaded seats 10 foreseen in the frame 6 are in any case made in metallic material, to avoid that an excessive tightening of the screws 12, is such to produce anti-aesthetic deformations on the frame 6 portion which remain visible when the cover plate 1 is assembled.

Preferably, the coupling means between the frame 6 and the base 2 permit the adjustment of the distance between the projecting portion 7 of the frame 6 and the base 2, so to be able to adapt such distance to the thickness of the mask 4, for example in order to ensure a certain interchangeability between a set of mask 4 of different thickness.

To obtain this adjustment, in several cases it is sufficient to adjust the level of tightening of the screws 12, alternatively it is possible to employ screws 12 of different length.

In a different embodiment, not represented in the figures, the adjustment may be obtained:
providing tongues on the bottom of the frame 6 which project in the direction of the base 2 and are equipped with a plurality of surface reliefs; and
providing coupling channels in the base 2 for receiving such tongues and internally provided with flexible teeth adapted to be engaged with such reliefs to be able to position the frame 6 at different distances with respect to the base 2.

In one alternative embodiment, not shown in the figures, it is possible to provide a coupling of non-removable type, for example by means of rivets, between the base 2 and the frame 6.

In a further embodiment, not shown in the figures, the base 3 and the frame 6 are removably coupled to each other by means of removable snap coupling means.

As shown in FIG. 1, the base 2 is provided with further fixing means 13 for coupling the base 2 to a mounting frame, for example to the frame shown in FIG. 8.

Such fixing means include, for example, tongues 13 which project from the bottom of the base 2 in the direction of the mounting frame 22 and are equipped on one side with a plurality of surface reliefs. Such tongues 13 are shaped so to be able to be received in respective fixing channels 23 foreseen in the frame 22. Preferably, each of such channels 23 is internally provided with a respective tooth adapted to be engaged with the reliefs of the respective received tongue 13. Advantageously, this permits being able to align the base 2 parallel to the fixing wall even when, due to an imperfect installation, the front part of the mounting frame is not perfectly parallel to such wall.

Nevertheless, it is clear to the man skilled in the art that fixing means of a type different from the particular tongues 13 may be foreseen for fixing the base 2, or more generally the cover plate 1, to a mounting frame installed to the wall.

In FIG. 7 a second embodiment is shown of a cover plate 21 in accordance with the present invention. It is observed that in such embodiment the mask 4 has an encircling conformation. In other words, the mask in addition to overlapping on a face of the base 2 is such to also be able to laterally encircle the base 2 by means of a perimeter edge portion 41 of the mask itself. It is observed that in FIG. 7 the mask 4 and the frame 6 are such to hide the base 2.

In FIG. 9 a lateral section view is shown with separated parts of a further, not limiting embodiment of a cover plate 1 in accordance with the present invention.

The plate 1 of FIG. 9 includes a sub-mask 15 with encircling frame which can be fixed to the base 2, for example by means of snap fixing means 17. The function of such sub-mask 15 is essentially aesthetic, since this advantageously permits perimetrically covering the lateral outside edge of the base 2 by simplifying in such a manner the productive process of the base 2, for example avoiding having to foresee particular working or colouring of the base 2 for aesthetic purposes.

In the cover plate 1, threaded seats 19 are visible in the frame 6, made for example in metal in a piece separate from the same frame 6 so to be subsequently fixed to this.

Moreover, the plate 1 of FIG. 9 includes a base 2 comprising a collar 16 which extends around the opening 3 of the base 2 to project inside the window 5 defined in the mask 4 and adapted to receive a part 9 of the frame 6 projecting inside said window 5.

Advantageously, by means of such collar 16, it is possible to snap fix the frame 6 and the base 2, for example by means of snap coupling elements 18 on such collar 16 adapted to cooperate with corresponding snap coupling elements defined on the frame 6.

The snap coupling elements 14, 18 are better visible in FIG. 11, which represents a section view along the Z-Z axis of the plate of FIG. 9. An enlarged detail of FIG. 11 is shown in FIG. 12. In particular, in the FIGS. 11 and 12, the snap coupling elements 14 and 18 are visible respectively on the frame 6 and on the collar of the base 2, which respectively are a small edge 14 made on the two opposite sides of the frame 6 and one or more tongues 18 made on the collar 16 and adapted to be engaged with such edge 14. Advantageously, such snap coupling means 14, 18 permit previously coupling the frame with the base 2, holding the mask 4 in position and facilitating the subsequent final fixing obtained by means of the coupling means 10 and 12, which in this particular example are screws 12 and corresponding threaded recesses 20.

From the above description it is possible to understand how the cover plate of the invention, for that which regards the differentiation aspects requested by the market and the previously referred to production costs, attains the pre-established object, permitting to satisfy the previously analysed contrasting needs.

In particular, it is observed that such plate, due to its modular structure, is such to simplify and make uniform much of the production process of a very numerous of different plates. In practice, the difference of such processes advantageously reduces to the single step of production of the masks. It is moreover observed that such production step of the masks is nevertheless simpler and less costly than the other steps, since it is not necessary to realise particular workings for the making base connection means in the mask.

For the same reason, it is moreover observed that not having to foresee such working, it is possible to make masks even of quite precious materials, or those that are difficult or costly, if not impossible, to work.

In the case wherein a fixing element 6 is provided shaped as a frame, it is advantageously possible to simplify the realisation of the mask by not having to finish the edge portion 8 of the mask facing the opening 5, since such frame covering such edge portion can hide possible imperfections, for example due to the cutting operating necessary for realising the opening 5 in the mask 4.

In the case wherein coupling means of removable type are provided between the fixing element 6 and the base 2, the same user may advantageously substitute the mask 4 with the maximum simplicity each time it is desired. One may refer, for example, to the case in which the walls of a room are repainted with a different colouring, or to the case in which the inside furnishing of the room is changed, and the need may arise to readjust the cover plates. Since the cover plate 1 according to the invention permits substituting the mask 4 with maximum simplicity, the advantage is evident which derives from this aspect of the invention. Moreover, in the case in which the use of a transparent mask is foreseen, for example made of glass, the possibility of interposing a sub-mask, for example in wallpaper fabric, between the mask 4 and the base 2, permits even wider possibilities of plate personalisation in accordance with the present invention.

Obviously, regarding the cover plate and group of parts described above, a man skilled in the art may make numerous modifications and variants in order to satisfy contingent and specific needs, all moreover falling with the scope of protection of the invention, as defined by the following claims.

1. Cover plate for the wall application of at least one electrical apparatus, comprising:
a base having a through opening adapted to receive a front portion of said at least one electrical apparatus;
a mask for coupling to the base and equipped with a window cooperating with said through opening and adapted to receive a front portion of said electrical apparatus;
at least one fixing element including a first portion adapted to project inside said window towards said base and comprising coupling means of said element to said base, said fixing element including moreover a second portion adapted to cooperate with at least one surface portion of said mask facing said window for fixing said base to said mask, wherein said coupling means permit removably coupling the fixing element to the base.

2. Cover plate according to claim 1, wherein said fixing element is operative to cooperate with said surface portion of said mask for pressure tightening said mask against said base.

3. Cover plate according to claim 1, wherein said surface portion of said mask includes a continuous edge portion of said mask which surrounds said window.

4. Cover plate according to claim 1, wherein said fixing element is a frame element which can be fixed to the base by means of said coupling means and wherein said second portion includes an edge of said frame element which projects coplanar with respect to a surface portion of the mask close to said window to interfere with such surface portion.

5. Cover plate according to claim 4, wherein said frame element is an annular element.

6. (canceled)

7. Cover plate according to claim 6, wherein said mask represents one of a set of interchangeable masks.

8. Cover plate according to claim 6, wherein said coupling means permit an adjustment of a distance between said second portion and said base so to realise matching to the thickness of said mask.

9. Cover plate (1) according to claim 6, wherein:
said coupling means include a plurality of fixing tongues which project from said fixing element towards said base, said tongues being equipped with a plurality of surface reliefs; and
said base includes corresponding channels adapted to receive such fixing tongues, each of said channels being internally provided with a tooth adapted to cooperate with such reliefs for the adjustment of said distance.

10. Cover plate according to claim 6, wherein:
said coupling means include at least one internally threaded seat which faces towards the base;
wherein said base includes at least one through hole aligned with said at least one seat and wherein said fixing element can be removably fixed to said base by means of at least one screw crossing such hole and screwable into said seat.

11. Cover plate according to claim 10, wherein said frame element is made in plastic material and wherein said internally threaded seats are metallic elements fixed to said frame element.

12. Cover plate according to claim 1, wherein said base is made in a plastic material.

13. Cover plate according to claim 1, wherein said mask is a sheet in one of the materials comprised in the following group: transparent glass, opaque glass, marble, slate, wood, steel.

14. Cover plate according to claim 1, wherein said mask is made in a substantially transparent material and wherein such plate includes an additional mask which can be interposed between said base and said mask.

15. Cover plate according to claim 1, wherein said coupling means include first and second coupling means and wherein said first coupling means permit snap coupling said fixing element to said base to facilitate a subsequent coupling of the fixing element to the base by means of said second coupling means.

16. Group of parts for the wall mounting of at least one electrical apparatus comprising:
a flush mounting frame operative to being affixed to walls and equipped with connection elements for receiving and holding said at least one electrical apparatus;
a cover plate according to claim 1, wherein said base further includes connection means for connecting said base to said flush frame and to permit the wall fixing of said cover plate.
